(19) United States
(12) Patent Application Publication
(10) Pub. No.: US 2014/0168643 A1
(43) Pub. Date: Jun. 19, 2014

(54) METHOD FOR INSPECTING DEFECTS OF OPTICAL LAYER ELEMENTS OF A DISPLAY DEVICE

(71) Applicant: TAIWAN POWER TESTING TECHNOLOGY CO., LTD., New Taipei City (TW)

(72) Inventor: Yu-Chiang LIN, New Taipei City (TW)

(21) Appl. No.: 13/848,239

(22) Filed: Mar. 21, 2013

(30) Foreign Application Priority Data
Dec. 17, 2012 (TW) 101147903

(51) Int. Cl. G01N 21/956

(52) U.S. Cl. CPC G01N 21/956
USPC 356/239.3

(57) ABSTRACT

Disclosed is a method for inspecting defects of optical layer elements of a display device. The method includes steps of: scanning a selected optical layer element of the display device by a scanning light beam at a predetermined scan angle, wherein the optical layer element is selected from a polarizing layer, a filter layer, an alignment layer, a liquid crystal layer, a thin film transistor substrate layer, a light diffusion layer, a light guide layer, or a combination thereof; retrieving a light pattern generated by scanning the selected optical layer element; generating an inspecting result information according to the light pattern in relation to the selected optical layer element; and analyzing the optical layer element regarding defect conditions according to the inspecting result information.

### CROSS-REFERENCE TO RELATED APPLICATION

This application claims priority to Taiwanese Patent Application No. 101147903, filed Dec. 17, 2012, which is hereby incorporated by reference.

### FIELD OF THE INVENTION

The present invention relates to a method for inspecting a display device, and more particularly to a method for inspecting defects of optical layer elements of a display device.

### BACKGROUND OF THE INVENTION

A display device, such as a TV or a computer screen, is for displaying image frames. With the development of modern technology, a conventional display device, such as a cathode ray tube (CRT), evolves to a thinner and more power-saving display device, such as a liquid crystal displays (LCD).

The LCD generally includes many optical layer elements, such as a polarizer layer, a filter layer, an alignment layer, a liquid crystal layer, a thin film transistor substrate layer, a diffusion layer and a light Guide layer. These optical layer elements usually are manufactured in different places, and then are transported to an assembly factory for assembly. These optical layer elements are manufactured by a lot of precise and complicated process, where even a little impropriety will cause a defect of these optical layer elements. Further, these optical layer elements face other factors of defect such as collision, breaks and scratches, on the way to the assembly factory. Therefore, a display device or its optical layer elements is required to be inspected of defects, including scratches, breaks and impurities, for quality test. The quality test of the above conventional inspection method is processed by human's vision of naked eyes.

### SUMMARY OF THE INVENTION

However, with the advance of manufacturing technology and the rise of the demand, the production capacity of display devices and optical layer elements is greatly increased, so the defect inspection is processed only by sampling inspection. For example, only several dozens of products are inspected in the total of one thousand products. The sampling inspecting method as above can merely speculate a rough defective rate, so that an ideal of 100 percent inspection cannot be achieved, and accordingly a defected product may be bought by a consumer. It, therefore, will burden the cost of producing company for product refund, and affect the image of the company as well.

Accordingly, an aspect of the present invention is for providing a method for inspecting defects of optical layer elements of a display device. The inspection method is used for inspecting defects of a selected optical layer element of the display deice, or inspecting defects of each optical layer element of a whole display device whose optical layers has been assembled.

The method includes following steps: (a) scanning a selected optical layer element of the display device by a scanning light beam at a predetermined scan angle, wherein the optical layer element is selected from a polarizing layer, a filter layer, an alignment layer, a liquid crystal layer, a thin film transistor substrate layer, a light diffusion layer, a light guide layer, or a combination thereof; (b) retrieving a light pattern generated by scanning the selected optical layer element; (c) generating an inspecting result information according to the light pattern in relation to the selected optical layer element; and (d) analyzing the optical layer element regarding defect conditions according to the inspecting result information.

In a preferred embodiment of the present invention, in the step (a), the light pattern is generated by reflecting the scanning light beam or projecting the scanning light beam through the selected optical layer element.

In a preferred embodiment of the present invention, in the step (a), the selected optical layer element is shifted along a transmission direction to pass through a projecting area projected by the scanning light beam.

In a preferred embodiment of the present invention, in the step (c), a positional mapping relation between the light pattern and the selected optical layer element determined according to the position of the selected optical layer element relative to the transmission direction.

In a preferred embodiment of the present invention, in the step (d), the defect of the selected optical layer element is analyzed according to the magnitude and the color level of the light pattern.

In a preferred embodiment of the present invention, it further comprises, after the step (d), a step of determining the selected optical layer element as a defective one while a quality of the defect of the selected optical layer element exceeds a predetermined level.

In a preferred embodiment of the present invention, it further comprises, after the step (d), a step (e) of processing the inspecting result information to obtain an inspecting map.

In a preferred embodiment of the present invention, it further comprises, after the step (e), a step of marking a problem area on the inspecting map according to a quality of the defect of the selected optical layer element.

In a preferred embodiment of the present invention, in the step (a), the selected optical layer element is transported by a transportation means to pass through a projecting area projected by the scanning light beam, and in the step (c), a positional mapping relation between the light pattern and the selected optical layer element is determined according to a transporting speed of the transportation means.

In a preferred embodiment of the present invention, in the step (a), a light-blocking layer element is placed on a side of the selected optical layer element opposite to the scanning light beam.

By means of technical means of this present invention, by the scanning light beam, various light patterns relative to various defects, such as scratches, breaks and impurities. And by a further detail inspection and a relational mapping, the size, the quantity, and the position of certain part of the defects can be know. This inspection method is nondestructive, and it functions well effective and is easy to be facilitated, applying to inspection of finished optical layer products of display devices and assembled display devices to increase the accuracy of inspection of the optical layers, and controlling the defective rate.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a flowchart illustrating the method of the one embodiment according to the present invention;

FIG. 2 to FIG. 3 are schematic diagrams illustrating the principle of the method of the one embodiment according to the present invention;

FIG. 4 is a schematic diagram illustrating an inspecting system performing the method of the one embodiment according to the present invention;

FIG. 5 is a schematic diagram illustrating one inspecting map of the one embodiment according to the present invention;

FIG. 6 is a schematic diagram illustrating another one inspecting map of the one embodiment according to the present invention;

FIG. 7 is a schematic diagram illustrating an inspecting system performing the method of the another one embodiment according to the present invention;

FIG. 8 is a schematic diagram illustrating an inspecting system performing the method of the another one embodiment according to the present invention;

FIG. 9 a schematic diagram illustrating an inspecting system performing the method of the another one embodiment according to the present invention.

### DETAILED DESCRIPTION OF THE PREFERRED EMBODIMENTS

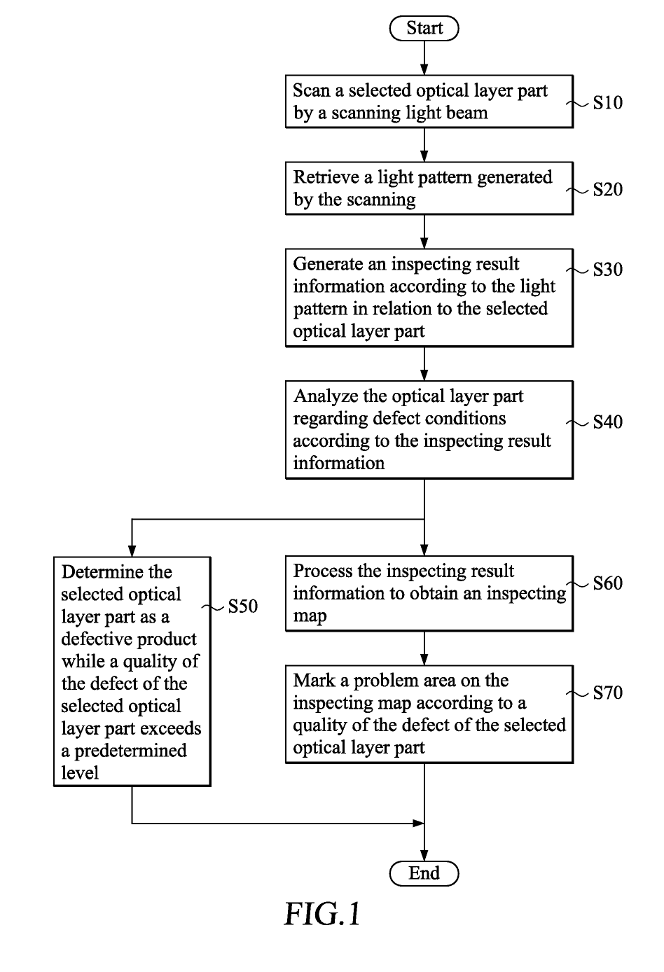

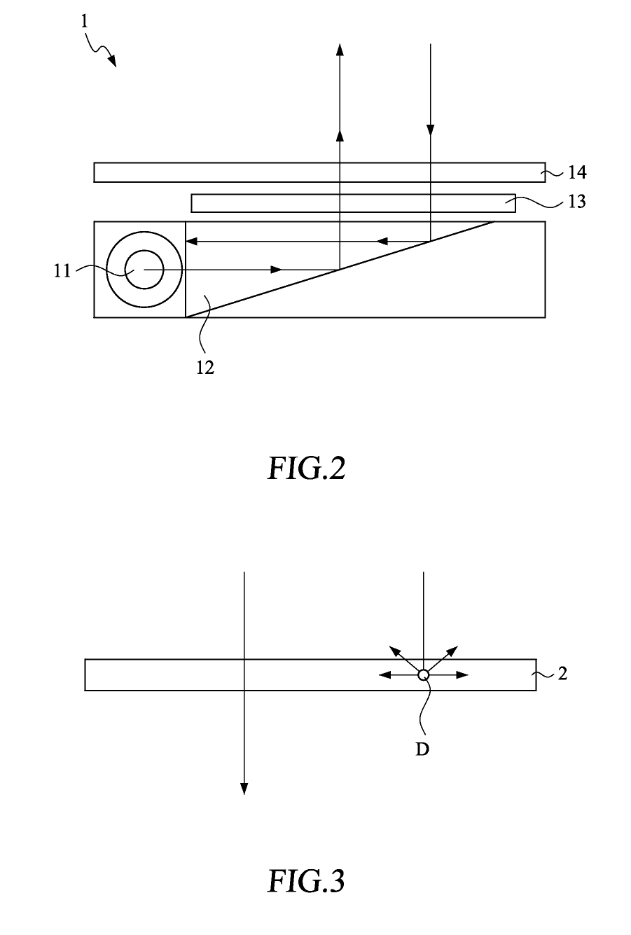

Refer to FIG. 1. FIG. 1 is a flowchart illustrating the method of one embodiment according to the present invention. And also Refer to FIG. 2-FIG. 6 with FIG. 1

The method of the present invention is provided for inspecting defects of a selected optical layer element 2 of a display device 1, wherein the selected optical layer element 2 is selected from a polarizing layer, a filter layer, an alignment layer, a liquid crystal layer, a thin film transistor substrate layer, a light diffusion layer, a light guide layer, or a combination thereof. An inspection principle of the method is based on optical properties that light transmits straightly, and based on a light guide path of the display device 1 which is accurate and identical.

As shown in FIG. 2, taking an edge-lit LCD as an example, the edge-lit LCD includes a light source 11 provided on the side thereof. The optical layer elements of the edge-lit LCD include a light guide layer 12, a light diffusion layer 13, and a display panel layer 14 from bottom to top. The light, which is produced from the light source 11, passes through the light guide layer 12 and the light diffusion layer 13 along an optical path P, and emits vertically from the display panel layer 14. A guide direction of each optical layer element substantially is identical for accurately guiding the light to emit the light through the display panel layer 14, and for providing light source of image frame. On the other hand, when a light is passed into the display panel layer 14 along an opposite direction, the light should pass through the display panel layer 14, the light diffusion layer 13, and the light guide layer 12 in sequence. So if any optical layer element has a defect, the light will be absorbed, reflected, and scattered by the defect. It leads to the result that the light can't pass along a predetermined path, so that it naturally brings a different optical effect compared to an optical effect of the optical layer element without a defect. Accordingly, the present invention inspects the defect of optical layer element according to the different optical effect. As shown in FIG. 3, when a left part of the selected optical layer element 2 has no defect, the light normally passes through the selected optical layer element 2. And when a right part of the selected optical layer element 2 has a defect, the light does not normally pass through the selected optical layer element 2.

The method can be applied to an inspecting system. The inspecting system includes an optical scanning means 3. The optical scanning means 3 includes a light source body 31, a light transmissive member 32, and a light sensitive member 33. The method includes following steps: scanning the selected optical layer element of the display device by a scanning light beam at a predetermined scan angle (Step S10); retrieving a light pattern generated by scanning the selected optical layer element (Step S20); generating an inspecting result information according to the light pattern in relation to the selected optical layer element (Step S30); and analyzing the selected optical layer element regarding defect conditions according to the inspecting result information (Step S40).

In order to clearly realize the condition of the defect, in a preferred embodiment, after step S40, it further comprises steps of: determining the selected optical layer element as a defective one while a quality of the defect of the selected optical layer element exceeds a predetermined level (Step S50); processing the inspecting result information to obtain an inspecting map (Step S60), and marking a problem area on the inspecting map according to a quality of the defect of the selected optical layer element (Step S70).

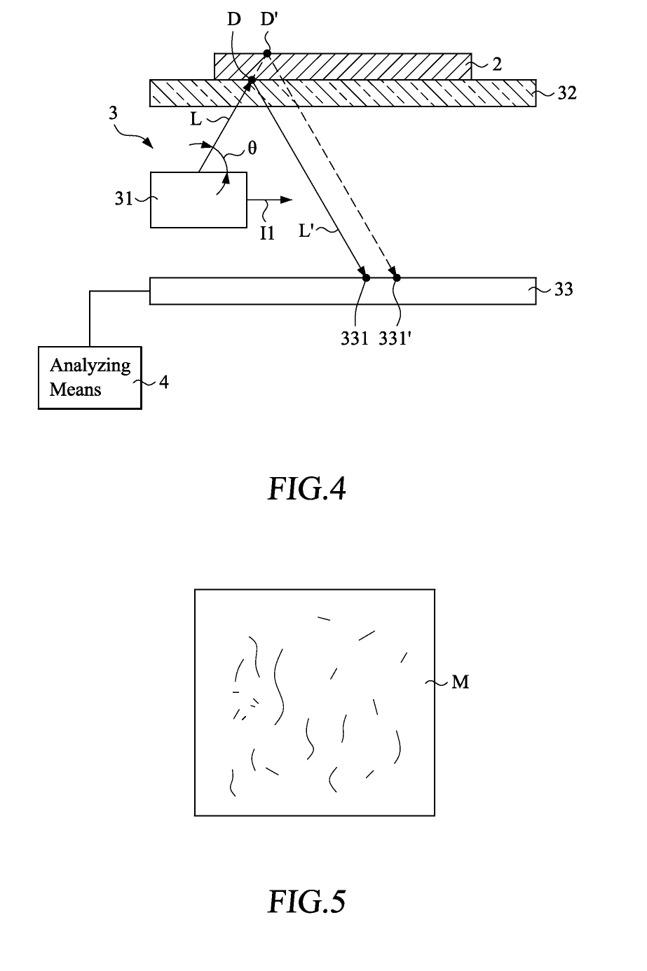

As shown in FIG. 4, first, the selected optical layer element 2 is disposed on the light transmissive member 32. Scan the selected optical layer element 2 with a scanning light beam L projecting from the light source body 31 at a predetermined scan angle θ (Step S10). Of course, the embodiment is not to limit the present invention. In other embodiments, a display device, which is composed of optical layer elements, is disposed on the light transmissive member to inspect. In the embodiment, the light source body 31 moves along a length direction I1 of the selected optical layer element 2, so that the scanning light beam L can scan all length of the selected optical layer element 2. Due to the light transmissive member 32 allows the light to pass through, the scanning light beam L can pass through the light transmissive member 32 to scan the selected optical layer element 2. In the Step S10, a light pattern is generated by having the scanning light beam L reflecting from the selected optical layer element 2, and the light pattern passes through the light transmissive member 32 to project on the light sensitive member 33.

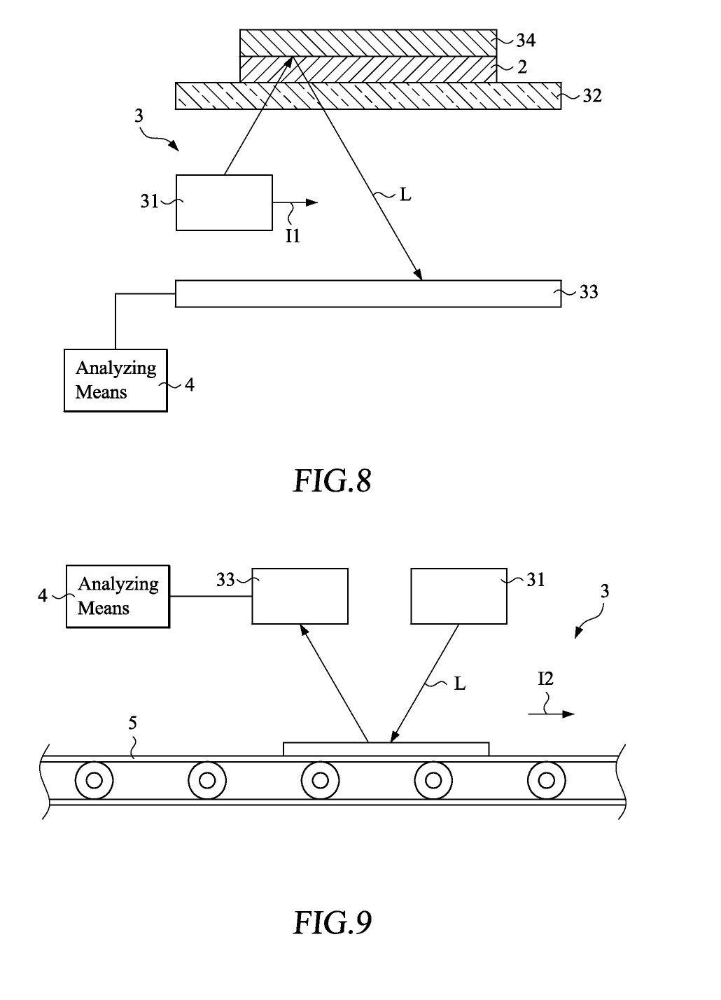

In addition, in other embodiments, the selected optical layer element 2 can be directly disposed on the light sensitive member 33, and the light pattern is generated by having the scanning light beam L, which is projected from the light source body 31, projecting through the selected optical layer element 2, and then the light pattern is directly projecting toward the light sensitive member 33, as shown in FIG. 7. Further, a light-blocking layer element 34 is placed on a side of the selected optical layer element 2 opposite to the scanning light beam L to increase the contrast intensity of the reflected light pattern image, as shown in FIG. 8. Furthermore, in the situation that the length of the selected optical layer element 2 is longer than that of the light sensitive member 33, in order to inspect all length of the selected optical layer element 2 regarding the defect, the selected optical layer element 2 is shifted to move along a transporting direction I2, which is paralleled to the length direction I1 of the selected optical layer element 2, to pass through a projecting area projected by the scanning light beam L projecting from the light source body 31, as shown in FIG. 9. The selected optical layer element 2 is disposed on a transporting means 5. The selected optical layer element 2 is transported by the transporting means 5, and passes along the transporting direction I2 through the projecting area projected by the scanning light beam L projecting from the light source body 31. By means of the transporting means 5, the light source body 31 and the selected optical layer element 2 move relatively to each other, so that the position of the light source body 31 can be fixed and that the light source body 31 does not have to move along the length direction I1 of the selected optical layer element 2, as shown in FIG. 4 and FIG. 7. By the above means, the present invention can be applied to a section of a present production line of the selected optical layer element 2 without largely changing the production process, and it brings the effect of equipment cost savings and quickly accurate inspection.

Meanwhile, the light sensitive member 33 retrieves a light pattern generated by scanning the selected optical layer element 2 (Step S20). The light pattern is transmitted to an analyzing means 4 connecting with the light sensitive member 33, so that the light sensitive member 33 generates an inspecting result information according to the light pattern in relation to the selected optical layer element 2 (Step S30). A positional mapping relation between the light pattern and the selected optical layer element 2 is determined according to the position of the scanning light beam L projecting on the light sensitive member 33. In the FIG. 9, a positional mapping relation between the light pattern and the selected optical layer element 2 is determined according to the position of the selected optical layer element 2 relative to the transporting direction I2. And the position of the selected optical layer element 2 relative to the transporting direction I2 can be determined according to a transporting speed of the transporting means 5. Further, because the scanning light beam L is absorbed, reflected, and scattered by the defect and the corresponding reflected beam L′ having various light intensity is generated, so the analyzing means 4 can analyze a size and a type of the defect. Furthermore, according to the predetermined scan angle θ and the photosensitive positions 331, 331′ corresponding to the defects D, D′ which are at different positions, a vertical position and a horizontal position of the defects are detected, as shown in FIG. 4. Besides, the accuracy of the inspecting result will be better with several different scan angles.

Then, the analyzing means 4 analyzes the selected optical layer element 2 regarding the defect according to the inspecting result information (Step S40), wherein the defect of the selected optical layer element 2 is analyzed by the analyzing means 4 according to the magnitude and the color level of the light pattern. And the position, the quantity, and the size of those also can be obtained.

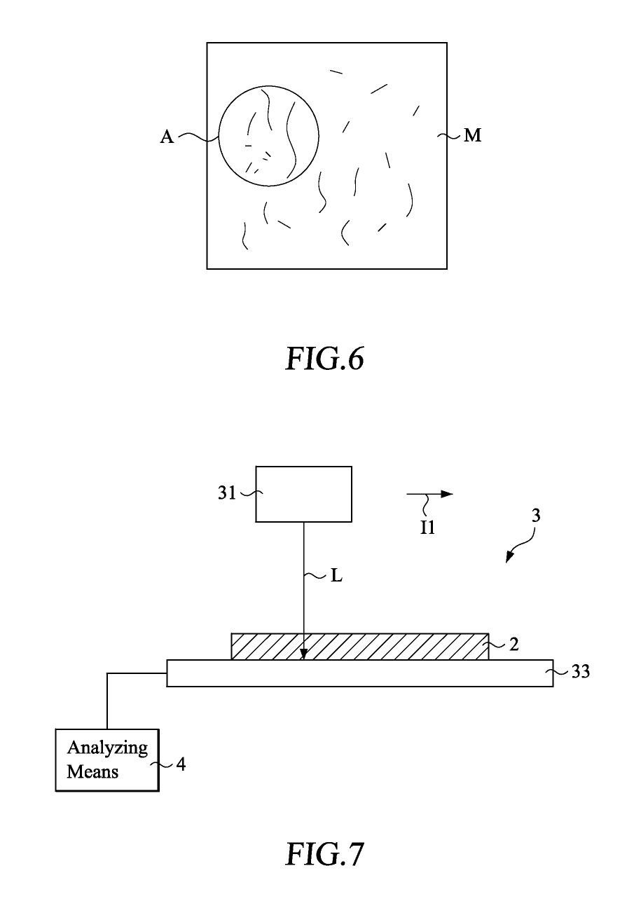

Furthermore, after Step S40, in the embodiment, a predetermined level is set in the analyzing means 4. The analyzing means 4 determines the selected optical layer element 2 as a defective one while a quality of the selected optical layer element 2 regarding the defect exceeds the predetermined level (Step S50). For example, the quantity of the defect exceeds 10, or the total area of the defect exceeds 1 cm2. Moreover, the analyzing means 4 further can process the inspecting result information to obtain an inspecting map M that provides an obvious image for observing the defect, as show in FIG. 5 (Step S60). In addition, the analyzing means 4 marks a problem area A on the inspecting map M according to the quality of the selected optical layer element 2 regarding the defect, as shown in FIG. 6 (Step S70). By means of the assistance, the severe problem area regarding the defect can be observed more directly.

The above description should be considered as only the discussion of the preferred embodiments of the present invention. However, a person skilled in the art may make various modifications to the present invention. Those modifications still fall within the spirit and scope defined by the appended claims.

What is claimed is:

1. A method for inspecting defects of optical layer elements of a display device, comprising steps of:
(a) scanning a selected optical layer element of the display device by a scanning light beam at a predetermined scan angle, wherein the optical layer element is selected from a polarizing layer, a filter layer, an alignment layer, a liquid crystal layer, a thin film transistor substrate layer, a light diffusion layer, a light guide layer, or a combination thereof;
(b) retrieving a light pattern generated by scanning the selected optical layer element;
(c) generating an inspecting result information according to the light pattern in relation to the selected optical layer element; and
(d) analyzing the optical layer element regarding defect conditions according to the inspecting result information.

2. The method as claimed in claim 1, wherein in the step (a), the light pattern is generated by reflecting the scanning light beam or projecting the scanning light beam through the selected optical layer element.

3. The method as claimed in claim 1, wherein in the step (a), the selected optical layer element is shifted along a transmission direction to pass through a projecting area projected by the scanning light beam.

4. The method as claimed in claim 3, wherein in the step (c), a positional mapping relation between the light pattern and the selected optical layer element determined according to the position of the selected optical layer element relative to the transmission direction.

5. The method as claimed in claim 1, wherein in the step (d), the defect of the selected optical layer element is analyzed according to the magnitude and the color level of the light pattern.

6. The method as claimed in claim 1, further comprising, after the step (d), a step of determining the selected optical layer element as a defective one while a quality of the defect of the selected optical layer element exceeds a predetermined level.

7. The method as claimed in claim 1, further comprising, after the step (d), a step (e) of processing the inspecting result information to obtain an inspecting map.

8. The method as claimed in claim 7, further comprising, after the step (e), a step of marking a problem area on the inspecting map according to a quality of the defect of the selected optical layer element.

9. The method as claimed in claim 1, wherein in the step (a), the selected optical layer element is transported by a transportation means to pass through a projecting area projected by the scanning light beam, and in the step (c), a positional mapping relation between the light pattern and the selected optical layer element is determined according to a transporting speed of the transportation means.

10. The method as claimed in claim 1, wherein in the step (a), a light-blocking layer element is placed on a side of the selected optical layer element opposite to the scanning light beam.
